(19) United States
(12) Patent Application Publication
(10) Pub. No.: US 2023/0391137 A1
(43) Pub. Date: Dec. 7, 2023

(54) Telehandler Having Tilt Axle With An Extendable Track

(71) Applicants: ZOOMLION Heavy Industry NA, Inc., Yorkville, WI (US); ZOOMLION Heavy Industry Science and Technology Co. Ltd., Changsha Hunan Province (CN)

(72) Inventor: Dave Berry, Whitefish Bay, WI (US)

(21) Appl. No.: 17/832,767

(22) Filed: Jun. 6, 2022

(51) Int. Cl. B60B 35/10

(52) U.S. Cl. CPC B60B 35/109; B60B 35/1054

(57) ABSTRACT

A telehandler having a tilt axle with an extendable track preferably includes a base frame, a front axle assembly and a rear axle assembly. The front axle assembly is pivotally retained on a lengthwise axis of the base frame at a front thereof and the rear axle assembly is pivotally retained on the lengthwise axis of the base frame at a rear thereof. Each axle assembly includes an axle beam, a left pivoting axle and a right pivoting axle. A front pivot cylinder is used to pivot the front axle assembly. A rear pivot cylinder is used to pivot the rear axle assembly. Left and right steering cylinders are used to pivot the left and right pivoting axles relative to the axle beam, respectively. Left and right extension cylinders are used to extend the left and right pivoting axles outward from the base frame and pivot with the axle beam.

### BACKGROUND OF THE INVENTION

### 1. Field of the Invention

The present invention relates generally to heavy equipment and more specifically to a telehandler having a tilt axle with an extendable track, which provides increased stability for lifting a load.

### 2. Discussion of the Prior Art

Since the introduction of the telehandler in the North American market, there has been little innovation in the telehandler transmission technology. Telehandlers have always used a transmission with a differential responsible for giving the machine a triangular stability line. To increase the stability of these machines, complex control systems have to be implemented such as locking a differential when the boom is raised above 40 degrees. Further, this type of transmission lends itself to unreliable drive when switching from four-wheel drive (4WD) or crab mode to two-wheel (2WD) drive mode. The issue is that there is no coordination between the rear wheels and the transmission axles. The operator has to visually adjust the rear wheels adding inconveniences to maneuver the telehandler while increasing downtime. Additionally, the rear wheels lose connection to the steering wheel when switching from the crab or four-wheel drive mode to two-wheel-drive mode. The rear wheels remain in an angled orientation and therefore are not in the two-wheel-drive mode orientation. In the two-wheel-drive mode, the rear wheels should be aligned alongside the frame, and only the steering of the front wheels is allowed.

Further, conventional telehandlers equipped with a transmission differential operate safely as long as the machine's center of gravity lies within the inner boundaries of the stability triangle formed between the two front wheels and the pivot point of the rear axle. However, as the load on the forklift is raised, the center of gravity moves up and away from the front wheels towards the apex of the stability triangle. On uneven grounds or side slopes, there is a higher risk that the center of gravity deviates sideways beyond the stability line, which risks tipping the telehandler over. U.S. Pat. No. 8,888,122 to Berry discloses a pivoting axle system. U.S. Pat. No. 10,221,055 to Hao et al. discloses a leveling system for lift device. U.S. Pat. No. 10,562,364 to Crook discloses a vehicle wheel positioning and steering apparatus.

Accordingly, there is clearly felt need in the art for a telehandler having a tilt axle with an extendable track, which provides increased stability for lifting a load; includes four self-propelled wheels; includes rear wheels that are automatically aligned alongside a telehandler frame when the steering mode is switched from crab or four-wheel drive modes to two-wheel-drive mode; and includes a pair of pivoting axles to increase leveling stability, while lifting a load.

### SUMMARY OF THE INVENTION

The present invention provides a telehandler having a tilt axle with an extendable track, which includes four self-propelled wheels and a pair of pivoting axles to increase leveling stability, while lifting a load. The telehandler having a tilt axle with an extendable track preferably includes a base frame, a front axle assembly and a rear axle assembly. The base frame preferably includes a first side plate, a second side plate, a pair of front-end plates, a pair of rear end plates, a front cross plate and a rear cross plate. The pair of front-end plates are secured between the first and second side plates at a front thereof. The pair of rear end plates are secured between the first and second side plates at a rear thereof. The front cross plate is located between the first and second side plates and behind the front-end plate. The rear cross plate is located between the first and second side plates and behind the rear end plate. A front cylinder bracket extends outward from the second side plate, adjacent the pair of front-end plates. A rear cylinder bracket extends outward from the first side plate, adjacent the pair of rear end plates.

The front axle assembly preferably includes a front axle beam, a left front pivoting axle, a right front pivoting axle and a vertical front cylinder bracket. The vertical front cylinder bracket is secured to an end of the front axle beam, adjacent the front cylinder bracket. A front beam pin is inserted through a middle of the pair of front end-plates and a center of the front axle beam. One end of a front beam cylinder is pivotal engaged with the front cylinder bracket. An opposing end of the front beam cylinder is pivotally engaged with the vertical front cylinder bracket. The left front pivoting axle preferably includes a left front axle base, a left front wheel hub and a left front steering cylinder. The left front axle base includes a lengthwise base member, an offset beam pivot member and a pair of obtuse wheel pivot plates. The offset beam pivot member extends outward from one end of the lengthwise base member and the pair of obtuse wheel pivot plates extend outward from an opposing end of the lengthwise base member. A left steering yoke extends outward from an opposing side of the lengthwise base member, adjacent the obtuse wheel pivot member. A left beam yoke is formed in the one end of the lengthwise base member to receive an end of the front axle beam. An extension cylinder yoke extends from a bottom of the left beam yoke. An axle pivot pin is inserted through the left beam yoke and one end of the front axle beam to pivotally engage the left front pivoting axle with the front axle beam.

The left front wheel hub preferably includes a left wheel base, a left drive motor and a left steering hub yoke. The left drive motor extends outward from the left wheel base. A wheel is removably secured to the left drive motor. A thickness of the left wheel base is sized to be received by the inside surfaces of the pair of obtuse wheel pivot plates. A left wheel pivot pin is inserted through an end of the pair of obtuse pivot plates and the left wheel base to pivotally engage left front wheel hub with the left front axle base. One end of the left steering cylinder is pivotally engaged with left steering yoke and the opposing end is pivotally engaged with left steering hub yoke.

A front extension base plate is preferably attached to the front cross plate. A front extension cylinder yoke is pivotally engaged with the front extension base plate and the front cross plate with front base pivot pin. The front extension cylinder yoke includes a yoke base plate and a front dual cylinder yoke. The front dual cylinder yoke extends from the yoke base plate. One end of a left extension cylinder is pivotally retained in the front dual cylinder yoke with an extension pivot pin. The other end of the left extension cylinder is pivotally retained in the left extension cylinder yoke with a left axle pivot pin.

The right front pivoting axle preferably includes a right front axle base, a right front wheel hub and a right front steering cylinder. The right front axle base includes the lengthwise base member, the offset beam pivot member and the pair of obtuse wheel pivot plates. The offset beam pivot member extends outward from one end of the lengthwise base member and the pair of obtuse wheel pivot plates extend outward from an opposing end of the lengthwise base member. A right steering yoke extends outward from an opposing side of the lengthwise base member, adjacent the obtuse wheel pivot member. A right beam yoke is formed in the one end of the lengthwise base member to receive an opposing end of the front axle beam. An extension cylinder yoke extends from a bottom of the right beam yoke. The axle pivot pin is inserted through the right beam yoke and the opposing end of the front axle beam to pivotally engage the right front pivoting axle with the front axle beam.

The right front wheel hub preferably includes a right wheel base, a right drive motor and a right steering hub yoke. One end of the right drive motor extends outward from the right wheel base. A wheel is removably secured to the right drive motor. A thickness of the right wheel base is sized to be received by the inside surfaces of the pair of obtuse wheel pivot plates. A right wheel pivot pin is inserted through an end of the pair of obtuse pivot plates and the right wheel base to pivotally engage right front wheel hub with the right front axle base. One end of the right steering cylinder is pivotally engaged with the right steering yoke and the opposing end is pivotally engaged with right steering hub yoke. One end of a right extension cylinder is pivotally retained in the front dual cylinder yoke with an extension pivot pin. The other end of the right extension cylinder is pivotally retained in the right extension cylinder yoke with a right axle pivot pin.

The rear axle assembly preferably includes a rear axle beam, a left rear pivoting axle, a right rear pivoting axle and a vertical rear cylinder bracket. The vertical rear cylinder bracket is secured to an end of the rear axle beam, adjacent the rear cylinder bracket. A rear beam pin is inserted through a middle of the pair of rear end-plates and a center of the rear axle beam. One end of a rear beam cylinder is pivotal engaged with the rear cylinder bracket. An opposing end of the rear beam cylinder is pivotally engaged with the vertical rear cylinder bracket.

The rear axle assembly is the same as the front axle assembly. The front axle assembly is rotated 180 degrees for installation in the rear of the base frame. A rear extension base plate is preferably attached to the rear cross plate. The rear extension base plate is the same as the front extension base plate. One end of the left extension cylinder is pivotally retained in a rear dual cylinder yoke with an extension pivot pin. The other end of the left extension cylinder is pivotally retained in the left extension cylinder yoke with a left axle pivot pin. One end of a right extension cylinder is pivotally retained in the rear dual cylinder yoke with an extension pivot pin. The other end of the right extension cylinder is pivotally retained in the right extension cylinder yoke with a right axle pivot pin. A frame end of the extension cylinders are allowed to rotate with the front and rear axle assemblies through the front and rear dual cylinder yokes.

Accordingly, it is an object of the present invention to provide a telehandler having a tilt axle with an extendable track, which provides increased stability for lifting a load.

It is another object of the present invention to provide a telehandler having a tilt axle with an extendable track, which includes four self-propelled wheels.

It is another object of the present invention to provide a telehandler having a tilt axle with an extendable track, which includes rear wheels that are automatically aligned alongside a telehandler frame when the steering mode is switched from crab or four-wheel drive modes to two-wheel-drive mode.

Finally, it is another object of the present invention to provide a telehandler having a tilt axle with an extendable track, which includes a pair of pivoting axles to increase leveling stability, while lifting a load.

These and additional objects, advantages, features and benefits of the present invention will become apparent from the following specification.

### BRIEF DESCRIPTION OF THE DRAWINGS

FIG. 1 is a top view of a telehandler having a tilt axle with an extendable track in accordance with the present invention.

FIG. 2 is a top view of a telehandler having a tilt axle with an extendable track with front and rear axle assemblies in an extended orientation; and a lift mechanism and cab removed to show a base frame thereof in accordance with the present invention.

FIG. 3 is an enlarged top view taken from FIG. 2 of left and right front extension cylinders pivotally connected to left and right extension dual cylinder yokes of left and right left front pivoting axles of a telehandler having a tilt axle with an extendable track in accordance with the present invention.

FIG. 4 is a partially exploded perspective view of a rear axle assembly without a right rear pivoting axle; with a left extension cylinder connected to the left rear pivoting axle and a rear cross plate and a front cross plate of a telehandler having a tilt axle with an extendable track in accordance with the present invention.

FIG. 5 is a top view of a left rear pivoting axle of a telehandler having a tilt axle with an extendable track in accordance with the present invention.

FIG. 6 is a rear view of a left rear pivoting axle of a telehandler having a tilt axle with an extendable track in accordance with the present invention.

FIG. 7 is an exploded perspective view of a right extension cylinder, a rear dual extension cylinder yoke, a rear extension base plate, a pivot pin and other components of a telehandler having a tilt axle with an extendable track in accordance with the present invention.

FIG. 8 is a front view of a telehandler having a tilt axle with an extendable track in accordance with the present invention.

FIG. 9 is a front view of a telehandler having a tilt axle with an extendable track with front and rear axle assemblies in an extended orientation in accordance with the present invention.

FIG. 10 is a front view of a telehandler having a tilt axle with an extendable track with front and rear axle assemblies in a tilted and extended orientation in accordance with the present invention.

FIG. 11 is a top view of a telehandler having a tilt axle with an extendable track with a lift mechanism and cab removed to show a base frame thereof in accordance with the present invention.

FIG. 12 is a bottom view of a telehandler having a tilt axle with an extendable track with a lift mechanism and cab removed to show a base frame thereof in accordance with the present invention.

FIG. 13 is a perspective view of a front wheel assembly pivotally retained on a front of a base frame of a telehandler having a tilt axle with an extendable track in accordance with the present invention.

### DETAILED DESCRIPTION OF THE PREFERRED EMBODIMENTS

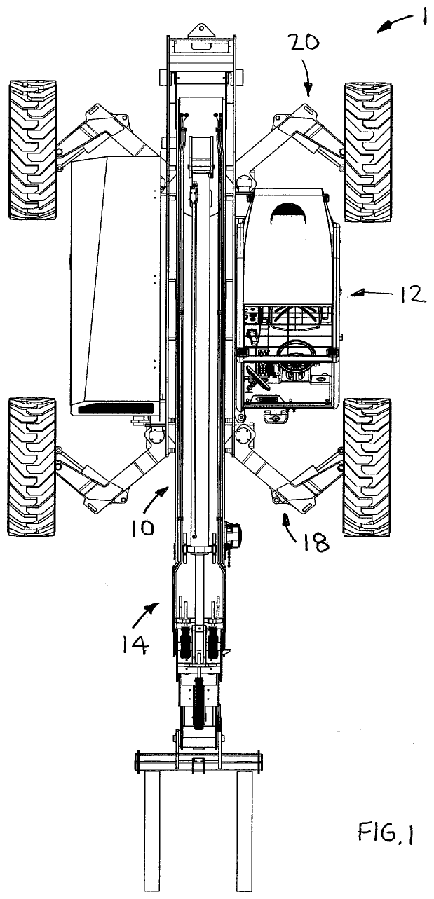

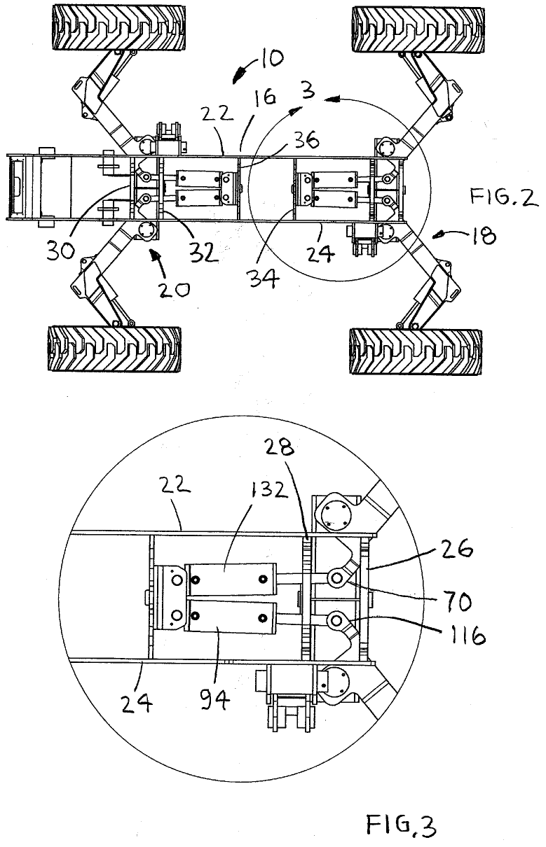

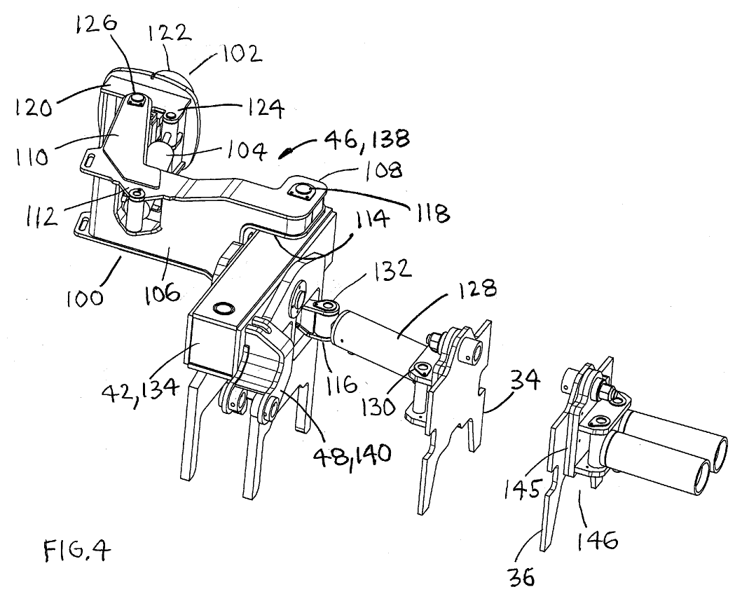

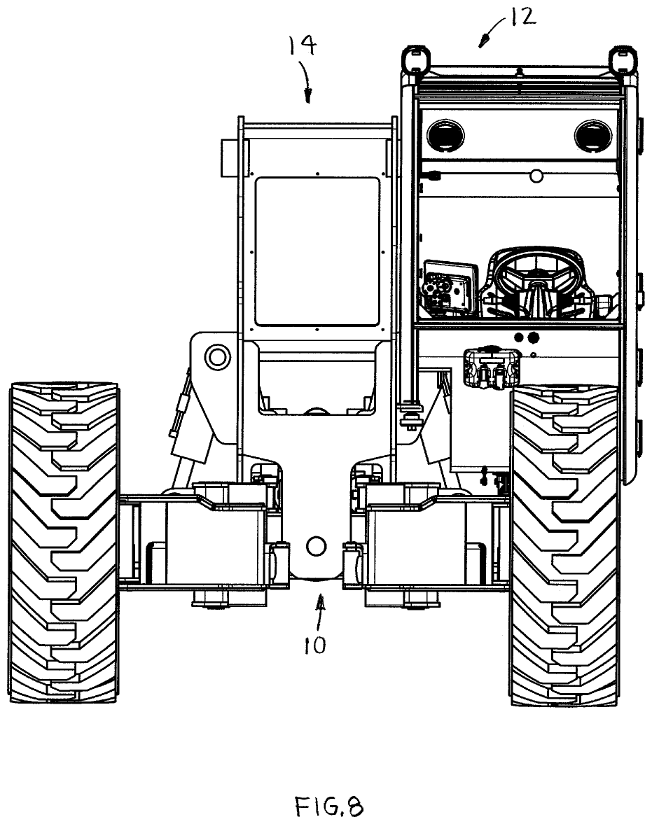

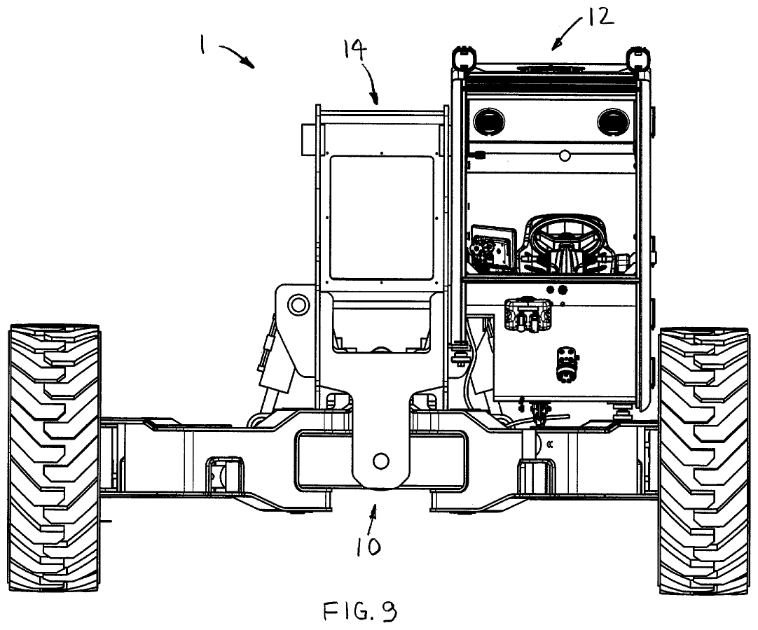

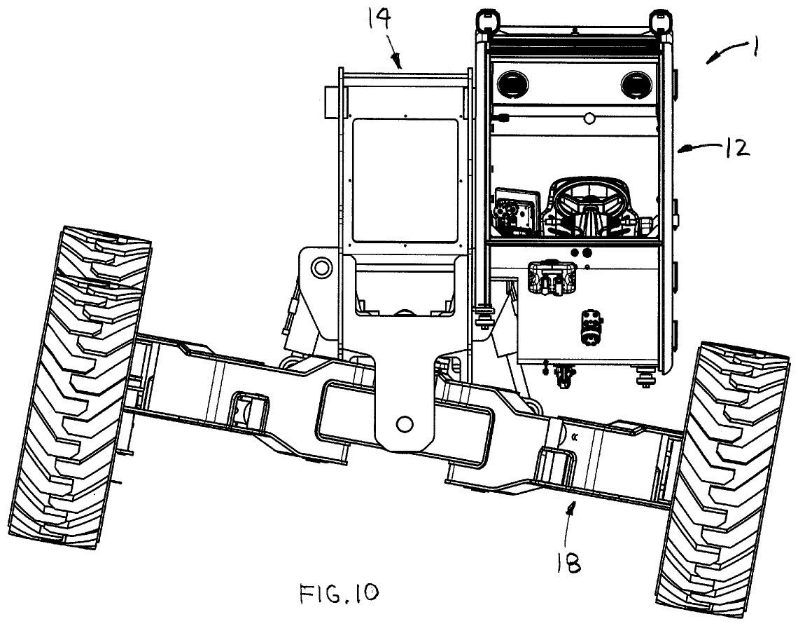

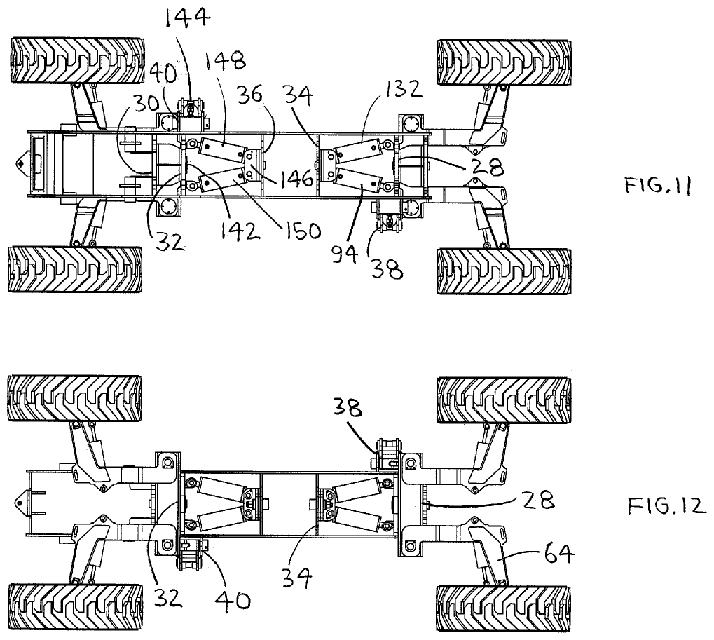

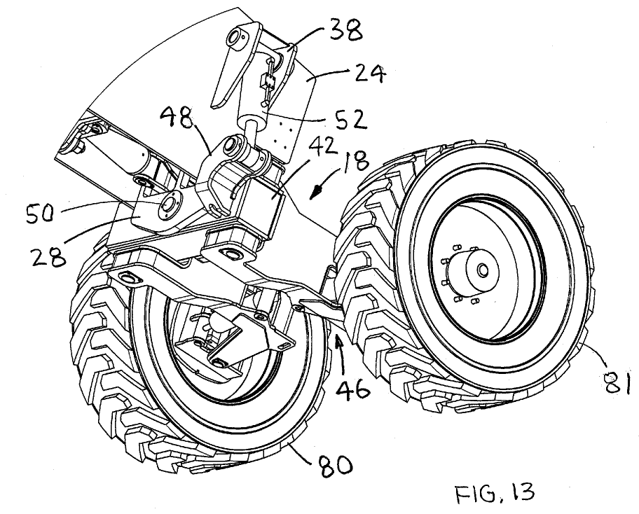

With reference now to the drawings, and particularly to FIG. 1, there is shown a top view of a telehandler having a tilt axle with an extendable track 1. With reference to FIGS. 2-3, the telehandler having a tilt axle with an extendable track 1 preferably includes a frame 10, a cab 12, a lift mechanism 14. The frame 10 preferably includes a base frame 16, a front axle assembly 18 and a rear axle assembly 20. The base frame 16 preferably includes a first side plate 22, a second side plate 24, a pair of front-end plates 26, 28, a pair of rear end plates 30, 32, a front cross plate 34 and a rear cross plate 36. The pair of front-end plates 26, 28 are secured between the first and second end plates 22, 24 at a front thereof. The pair of rear end plates 30, 32 are secured between the first and second end plates 22, 24 at a rear thereof. The front cross plate 34 is located between the first and second side plates 22, 24 and behind the front-end plate 28. The rear cross plate 36 is located between the first and second side plates 22, 24 and behind the rear end plate 32. With reference to FIGS. 7-12, a front cylinder bracket 38 extends outward from the second side plate 24, adjacent the front-end plate 28. A rear cylinder bracket 40 extends outward from the first side plate 22, adjacent the rear end plate 32.

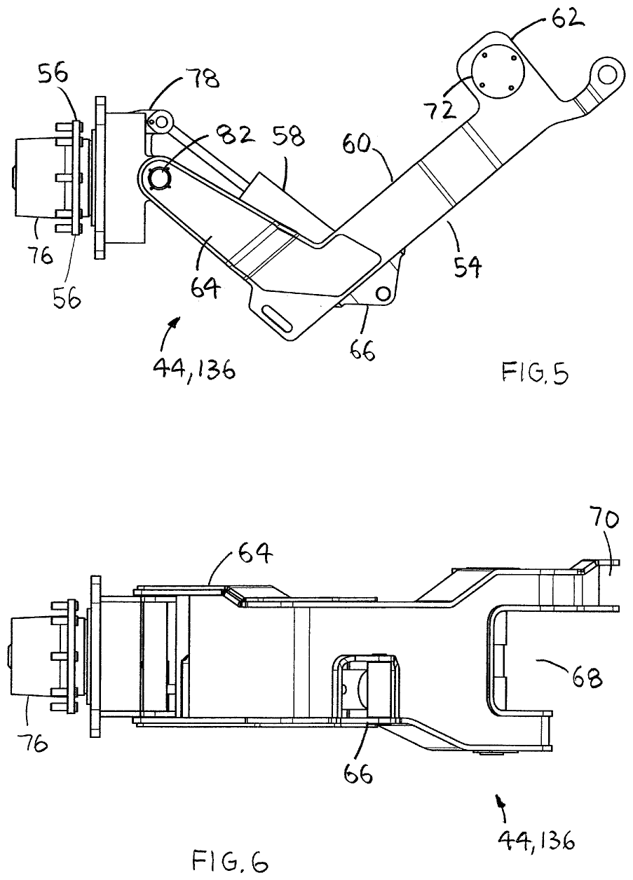

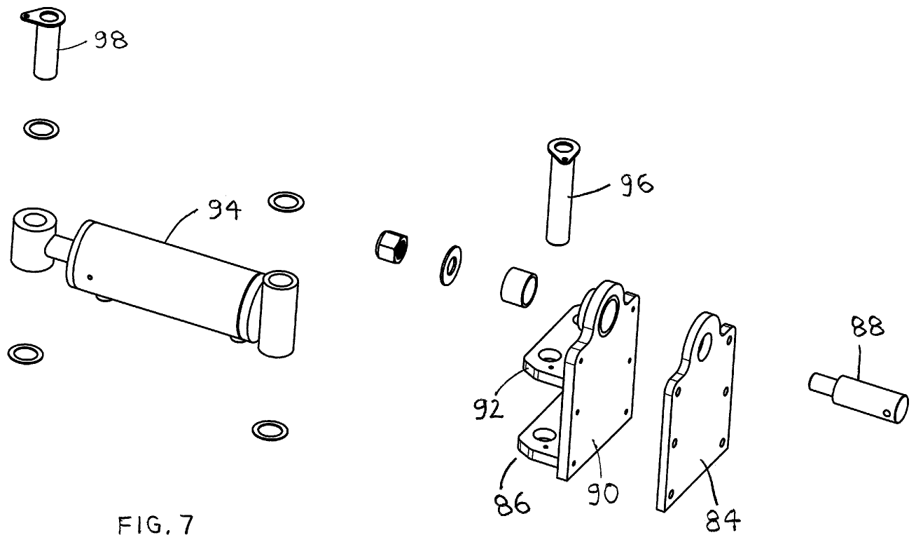

With reference to FIGS. 4-6, the front axle assembly 18 preferably includes a front axle beam 42, a left front pivoting axle 44, a right front pivoting axle 46 and a vertical front cylinder bracket 48. The vertical front cylinder bracket 48 is secured to an end of the front axle beam 42, adjacent the front cylinder bracket 38. A front beam pin 50 is inserted through a middle of the pair of front end-plates 26, 28 and a center of the front axle beam 42. One end of a front beam cylinder 52 is pivotal engaged with the front cylinder bracket 38. An opposing end of the front beam cylinder 52 is pivotally engaged with the vertical front cylinder bracket 48. The left front pivoting axle 44 preferably includes a left front axle base 54, a left front wheel hub 56 and a left front steering cylinder 58. The left front axle base 54 includes a lengthwise base member 60, an offset beam pivot member 62 and a pair of obtuse wheel pivot plates 64. The offset beam pivot member 62 extends outward from one end of the lengthwise base member 60 and the pair of obtuse wheel pivot plates 62 extend outward from an opposing end of the lengthwise base member 60. A left steering yoke 66 extends outward from the lengthwise base member 60, adjacent the obtuse wheel pivot member 64. A left beam yoke 68 is formed in the one end of the lengthwise base member 60 to receive an end of the front axle beam 42. An extension cylinder yoke 70 extends from a bottom of the left beam yoke 68. An axle pivot pin 72 is inserted through the left beam yoke 68 and one end of the front axle beam 42 to pivotally engage the left front pivoting axle 44 with the front axle beam 42.

The left front wheel hub 56 preferably includes a left wheel base 74, a left drive motor 76 and a left steering hub yoke 78. The left drive motor 76 extends outward from the left wheel base 74. A wheel 80 is removably secured to the left drive motor 76. A thickness of the left wheel base 74 is sized to be received by inside surfaces of the pair of obtuse wheel pivot plates 64. A left wheel pivot pin 82 is inserted through an end of the pair of obtuse pivot plates 64 and the left wheel base 74 to pivotally engage the left front wheel hub 56 with the left front axle base 54. One end of the left steering cylinder 58 is pivotally engaged with left steering yoke 66 and the opposing end is pivotally engaged with left steering hub yoke 78.

A front extension base plate 84 is preferably attached to the front cross plate 34. A front extension cylinder yoke 86 is pivotally engaged with the front extension base plate 84 and the front cross plate 34 with front base pivot pin 88. The front extension cylinder yoke 86 includes a yoke base plate 90 and a front dual cylinder yoke 92. The front dual cylinder yoke 92 extends from the yoke base plate 90. One end of a left extension cylinder 94 is pivotally retained in the front dual cylinder yoke 92 with an extension pivot pin 96. The other end of the left extension cylinder is pivotally retained in the extension cylinder yoke 70 with a left extension pivot pin 98.

The right front pivoting axle 46 preferably includes a right front axle base 100, a right front wheel hub 102 and a right front steering cylinder 104. The right front axle base 100 includes a lengthwise base member 106, the offset beam pivot member 108 and the pair of obtuse wheel pivot plates 110. The offset beam pivot member 108 extends outward from one end of the lengthwise base 106 member and the pair of obtuse wheel pivot plates 110 extend outward from an opposing end of the lengthwise base member 106. A right steering yoke 112 extends outward from an opposing side of the lengthwise base member 106, adjacent the obtuse wheel pivot plates 110. A right beam yoke 114 is formed in the one end of the lengthwise base member 106 to receive an opposing end of the front axle beam 42. An extension cylinder yoke 116 extends from a bottom of the right beam yoke 114. A right axle pivot pin 118 is inserted through the right beam yoke 114 and the opposing end of the front axle beam 42 to pivotally engage the right front pivoting axle 46 with the front axle beam 42.

The right front wheel hub 102 preferably includes a right wheel base 120, a right drive motor 122 and a right steering hub yoke 124. The right drive motor 122 extends from the right wheel base 120. A wheel 81 is removably secured to the right drive motor 122. A thickness of the right wheel base 120 is sized to be received by the inside surfaces of a pair of obtuse wheel pivot plates 110. A right wheel pivot pin 126 is inserted through an end of the pair of obtuse pivot plates 110 and the right wheel base 120 to pivotally engage right front wheel hub 102 with the right front axle base 100. One end of the right steering cylinder 104 is pivotally engaged with right steering yoke 112 and the opposing end is pivotally engaged with right steering hub yoke 124. One end of a right extension cylinder 128 is pivotally retained in the front dual cylinder yoke 92 with an extension pivot pin 130. The other end of the right extension cylinder 128 is pivotally retained in the extension cylinder yoke 116 with a right extension pivot pin 132. The drive motors 76, 122 are driven by hydraulic fluid or electricity.

The rear axle assembly 20 preferably includes a rear axle beam 134, a left rear pivoting axle 136, a right rear pivoting axle 138 and a vertical rear cylinder bracket 140. The vertical rear cylinder bracket 140 is secured to an end of the rear axle beam 134, adjacent the rear cylinder bracket 40. A rear beam pin 142 is inserted through a middle of the pair of rear end-plates 30, 32 and a center of the rear axle beam 134. One end of a rear beam cylinder 144 is pivotal engaged with the rear cylinder bracket 40. An opposing end of the rear beam cylinder 144 is pivotally engaged with the vertical rear cylinder bracket 140.

The rear axle assembly 20 is the same as the front axle assembly 18. The front axle assembly 18 is rotated 180 degrees for installation in the rear of the base frame 16. A rear extension base plate 145 is preferably attached to the rear cross plate 36. The rear extension base plate 145 is the same as the front extension base plate 86. One end of the left extension cylinder 148 is pivotally retained in a rear dual cylinder yoke 146 with an extension pivot pin. The other end of the left extension cylinder 148 is pivotally retained in the extension cylinder yoke 128 with a left axle pivot pin. One end of a right extension cylinder 150 is pivotally retained in the rear dual cylinder yoke 146 with an extension pivot pin. The other end of the right extension cylinder 150 is pivotally retained in the extension cylinder yoke 70 with a right axle pivot pin. A frame end of the extension cylinders 94,132,148,150 are allowed to rotate with the front and rear axle assemblies 18, 20 through the front and rear dual cylinder yokes 86,146.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed:

1. A telehandler having a tilt axle with an extendable track, comprising:
a front axle assembly including a front axle beam, a right front pivoting axle and a left front pivoting axle, said right front pivoting axle is pivotally engaged with one end of said front axle beam, said left front pivoting axle is pivotally engaged with an opposing end of said front axle beam;
a rear axle assembly including a rear axle beam, a right rear pivoting axle and a left rear pivoting axle, said right rear pivoting axle is pivotally engaged with one end of said rear axle beam, said left rear pivoting axle is pivotally engaged with an opposing end of said rear axle beam; and
a base frame having said front axle assembly pivotally engaged with a front of said base frame, said rear axle assembly is pivotally engaged with a rear of said base frame, wherein said right and left front pivoting axles are extendable outward from opposing sides of said base frame, said right and left rear pivoting axles are extendable outward from opposing sides of said base frame.

2. The telehandler having a tilt axle with an extendable track of claim 1, further comprising:
a right front extension cylinder for extending said right front pivoting axle, a left front extension cylinder for extending said left front pivoting axle, a right rear extension cylinder for extending said right front pivoting axle and a left front extension cylinder for extending said left front pivoting axle.

3. The telehandler having a tilt axle with an extendable track of claim 2 wherein:
said base frame including a front cross plate and a rear cross plate.

4. The telehandler having a tilt axle with an extendable track of claim 3, further comprising:
a front extension cylinder yoke is pivotally engaged with said front cross plate, a rear extension cylinder yoke is pivotally engaged with said rear cross plate.

5. The telehandler having a tilt axle with an extendable track of claim 4 wherein:
one end of said right and left front extension cylinders are pivotally engaged with said front extension cylinder yoke, an opposing end of said right and left front extension cylinders are pivotally engaged with said right and left front pivot axles; and
one end of said right and left rear extension cylinders are pivotally engaged with said rear extension cylinder yoke, an opposing end of said right and left rear extension cylinders are pivotally engaged with said right and left rear pivot axles.

6. A telehandler having a tilt axle with an extendable track, comprising:
a front axle assembly including a front axle beam, a right front pivoting axle and a left front pivoting axle, said right front pivoting axle is pivotally engaged with one end of said front axle beam, said left front pivoting axle is pivotally engaged with an opposing end of said front axle beam;
a rear axle assembly including a rear axle beam, a right rear pivoting axle and a left rear pivoting axle, said right rear pivoting axle is pivotally engaged with one end of said front axle beam, said left rear pivoting axle is pivotally engaged with an opposing end of said front axle beam, each said pivoting axle includes a lengthwise base member, a drive hub and a steering cylinder, one end of said cylinder is pivotally engaged with said lengthwise base member and an opposing end is pivotally engaged with said drive hub; and
a base frame having said front axle assembly pivotally engaged with a front of said base frame, said rear axle assembly is pivotally engaged with a rear of said base frame, wherein said right and left front pivoting axles are extendable outward from opposing sides of said base frame, said right and left rear pivoting axles are extendable outward from opposing sides of said base frame.

7. The telehandler having a tilt axle with an extendable track of claim 6, further comprising:
a right front extension cylinder for extending said right front pivoting axle, a left front extension cylinder for extending said left front pivoting axle, a right rear extension cylinder for extending said right front pivoting axle and a left front extension cylinder for extending said left front pivoting axle.

8. The telehandler having a tilt axle with an extendable track of claim 7 wherein:
said base frame including a front cross plate and a rear cross plate.

9. The telehandler having a tilt axle with an extendable track of claim 8, further comprising:
a front extension cylinder yoke is pivotally engaged with said front cross plate, a rear extension cylinder yoke is pivotally engaged with said rear cross plate.

10. The telehandler having a tilt axle with an extendable track of claim 9 wherein:
one end of said right and left front extension cylinders are pivotally engaged with said front extension cylinder yoke, an opposing end of said right and left front extension cylinders are pivotally engaged with said right and left front pivot axles; and
one end of said right and left rear extension cylinders are pivotally engaged with said rear extension cylinder yoke, an opposing end of said right and left rear extension cylinders are pivotally engaged with said right and left rear pivot axles.

11. The telehandler having a tilt axle with an extendable track of claim 6 wherein:
said drive hub includes a wheel base, a drive motor and a steering hub yoke, said drive motor extends from said drive base, said steering hub yoke extends from said drive base, said hub yoke is pivotally engaged with one end of said steering cylinder.

12. The telehandler having a tilt axle with an extendable track of claim 6, further comprising:
a front beam cylinder having one end pivotally engaged with an end of said front axle assembly, an opposing end of said front beam cylinder is pivotally engaged with a side of said base frame; and
a rear beam cylinder having one end pivotally engaged with an end of said rear axle assembly, an opposing end of said rear beam cylinder is pivotally engaged with an opposing side of said base frame.

13. A telehandler having a tilt axle with an extendable track, comprising:
a front axle assembly including a front axle beam, a right front pivoting axle and a left front pivoting axle, said right front pivoting axle is pivotally engaged with one end of said front axle beam, said left front pivoting axle is pivotally engaged with an opposing end of said front axle beam;
a rear axle assembly including a rear axle beam, a right rear pivoting axle and a left rear pivoting axle, said right rear pivoting axle is pivotally engaged with one end of said front axle beam, said left rear pivoting axle is pivotally engaged with an opposing end of said front axle beam, each said pivoting axle includes a lengthwise base member, a drive hub and a steering cylinder, one end of said cylinder is pivotally engaged with said lengthwise base member and an opposing end is pivotally engaged with said drive hub; and
a base frame having said front axle assembly pivotally engaged with a front of said base frame along a lengthwise axis of said base frame, said rear axle assembly is pivotally engaged with a rear of said base frame along a lengthwise axis of said base frame, wherein said right and left front pivoting axles are extendable outward from opposing sides of said base frame, said right and left rear pivoting axles are extendable outward from opposing sides of said base frame.

14. The telehandler having a tilt axle with an extendable track of claim 13, further comprising:
a right front extension cylinder for extending said right front pivoting axle, a left front extension cylinder for extending said left front pivoting axle, a right rear extension cylinder for extending said right front pivoting axle and a left front extension cylinder for extending said left front pivoting axle.

15. The telehandler having a tilt axle with an extendable track of claim 14 wherein:
said base frame including a front cross plate and a rear cross plate.

16. The telehandler having a tilt axle with an extendable track of claim 15, further comprising:
a front extension cylinder yoke is pivotally engaged with said front cross plate, a rear extension cylinder yoke is pivotally engaged with said rear cross plate.

17. The telehandler having a tilt axle with an extendable track of claim 16 wherein:
one end of said right and left front extension cylinders are pivotally engaged with said front extension cylinder yoke, an opposing end of said right and left front extension cylinders are pivotally engaged with said right and left front pivot axles; and
one end of said right and left rear extension cylinders are pivotally engaged with said rear extension cylinder yoke, an opposing end of said right and left rear extension cylinders are pivotally engaged with said right and left rear pivot axles.

18. The telehandler having a tilt axle with an extendable track of claim 13 wherein:
said drive hub includes a wheel base, a drive motor and a steering hub yoke, said drive motor extends from said drive base, said steering hub yoke extends from said drive base, said hub yoke is pivotally engaged with one end of said steering cylinder.

19. The telehandler having a tilt axle with an extendable track of claim 13, further comprising:
a front beam cylinder having one end pivotally engaged with an end of said front axle assembly, an opposing end of said front beam cylinder is pivotally engaged with a side of said base frame; and
a rear beam cylinder having one end pivotally engaged with an end of said rear axle assembly, an opposing end of said rear beam cylinder is pivotally engaged with an opposing side of said base frame.

20. The telehandler having a tilt axle with an extendable track of claim 13, further comprising:
said drive hub is self-propelled by hydraulic fluid or electricity.
